(19) United States
(12) Patent Application Publication
(10) Pub. No.: US 2015/0253793 A1
(43) Pub. Date: Sep. 10, 2015

(54) Appliance Shut-Off Device

(71) Applicant: LifeSmart Electronics, LLC, Saltsburg, PA (US)

(72) Inventor: Joseph Michael Matesa, JR., Murrysville, PA (US)

(73) Assignee: LIFESMART ELECTRONICS, LLC, Saltsburg, PA (US)

(21) Appl. No.: 14/195,881

(22) Filed: Mar. 4, 2014

(51) Int. Cl. G05F 1/66; G05B 15/02

(52) U.S. Cl. CPC G05F 1/66; G05B 15/02

(57) ABSTRACT

An apparatus for shutting-off electrical appliances and electrical devices upon detection of an audible alarm issued by a separate fire alarm. The separate fire alarm device generates an audible warning upon detecting fire. The shutting off device make use of these ever improving ubiquitous fire alarms to greatly reduce the cost and complexity of providing a power shut-off response in the case of fire. The shut-off device includes a switch to interrupt electrical power to an appliance, the switch is activated by a microphone for detecting an audible alarm.

### FIELD OF THE INVENTION

This invention relates to a method and apparatus for reducing damage caused by the malfunction of electrically-powered appliances and devices. An apparatus and method for responding to an audible alarm and more particularly to an apparatus and method for detecting a fire alarm warning sound, upon detecting the fire alarm the electrical power supply at a receptacle is shut-off reducing the likelihood of extensive fire damage to property.

### BACKGROUND OF THE INVENTION

Compact fire alarms include inexpensive battery-operated, self-contained circuitry and apparatus that are capable of unattended operation at diverse locations around a dwelling or other structure to detect abnormal amounts of smoke or heat as an indication of a fire, and upon detection produce a continuous loud alarm tone intended to alert occupants of the dwelling or structure to the danger. It should be appreciated that compact fire alarm technology has substantially improved from employing a basic photoelectric cell sensor in first designs such as disclosed in U.S. Pat. No. 3,460,124 (Smith et al.). More current fire detector technology, such as disclosed in U.S. Pat. No. 5,764,142 (Anderson et al.), U.S. Pat. No. 7,075,445 (Booth et al.), and U.S. Pat. No. 6,515,589 (Schneider et al.) are more accurate at sensing a fire. Other more current compact fire alarms have two detectors U.S. Pat. No. 6,362,743 (Tanguay et al.) discloses a fire alarm that employs both an ionization detector and photoelectric detector. In an article published on the www at www.ConsumersReports.org, last updated June 2013, the article described improved available compact smoke alarms that combined both an ionization detector and photoelectric detector for detecting two different type fires. And it is anticipated that compact fire alarm detector technology will continue to improve and advance.

Such self-contained smoke alarms may be positioned in numerous locations about a dwelling or structure as an add-on after construction of the structure and be dependable for sounding the tone upon detection of fire conditions. Because many such devices may be positioned around a structure, it has not been convenient to hard wire connections to the smoke alarm devices. Such wiring can be expensive to install and often is not aesthetically pleasing.

In addition, such self contained common place smoke alarms do not proactively assist in attenuating the cause of a fire themselves, they just sound the alarm. Accordingly, if no persons are around to hear the alarm, no human responses can be expected to contain the destructive effect of fire.

Every year in the United States tens of thousands of destructive fires are started by malfunctioning major appliances. In many instances these fires could have been avoided if only the electrical power supply to the major appliance would have been timely cut-off.

Many fire prevention systems have been developed in the prior art to enhance safety in situations where electrical appliances and devices are used. For example, the typical residential circuit breaker senses abnormally large electric currents and interrupts the supply of electrical power under such circumstances. Despite such circuit breakers many fires are started by malfunctioning appliances and electrical devices. There are many fire hazard situations created by electrical devices and appliances that do not involve an abnormally large electric current.

Of particular concern are clothes dryer fires. In the United States over 15,000 fires are started annually by clothes dryers. A clothes dryer operates by drawing in ambient air with a blower, raising the temperature of this air with a heating means, blowing the heated air across the clothes and then exhausting the air outside of the dryer through a vent duct. Should a small fire start inside an overheated clothes dryer the ambient air being drawn into the dryer provides an abundant source of oxygen to the flame. If the dryer is turned off and the blower stops, the fire within the dryer generally smolders for a while and ultimately is extinguished. It is contemplated that the internal fire quickly depletes the oxygen within the clothes dryer cabinet and suffocates. However if a fire starts inside the dryer and the blower continues to operate circulating additional air into the dryer, the fire grows rapidly.

An example of a safety system for an electrically-powered clothes dryer is disclosed in U.S. Pat. No. 6,655,047 (Miller II), which is incorporated herein by reference. Miller '047 discloses a fire arrestor for use with a clothes dryer that includes a fire detector within the dryer vent to detect fires starting in the dryer and an electrical power disconnect means to break the flow of electrical power being supplied to operate the dryer. Central to this concept is the installation of a fire detector at the dryer exhaust. Such installation is relatively inconvenient to carry out on dryers that previously have been put into service. Further modifying a dryer as shown in Miller '047 would result in relatively substantial hardware expenses as well as lost time installing a somewhat complex fire fighting system. Also it should be noted that as fire detector technology advances in the art that the fire detector at 30 in Miller '047 will either have to be replaced or such a fire arrestor will fall behind the state-of-the-art.

Every year in the United States alone thousands of domestic fires are started by malfunctioning clothes dryers. Many of the clothes dryer fires that occur each year are caused by lint or some other debris blocking the exhaust duct, typically at the dryer lint trap. It follows that to place the fire detector inside the exhaust vent as described in U.S. Pat. No. 6,655,047 may be ineffective. When a dryer exhaust vent becomes blocked then a detector positioned in the exhaust duct will be less able to continue to effectively sample the exhaust air.

Because an open exhaust vent passage is critical to the safe operation of a dryer, cleaning out the lint trap can save lives and property, and should be done frequently. However, in day-to-day use of the dryer, users often become complacent, and are not diligent in performing regular lint trap checks and the dryer exhaust becomes blocked.

Therefore, there is a need in the art for an automatic fire fighting shut-off apparatus which is unobtrusive in appearance, is relatively compact, and does not require a prohibitive amount of added hardware expense. In addition, there is also a need for an automatic shut-off apparatus for disconnecting the power, which is simple in design and does not require an expert to assist in the installation. The present invention addresses these shortcomings and provides a compact and reliable fire fighting system that can assist in terminating a fire caused by an appliance.

### SUMMARY OF THE INVENTION

The present invention in a general and overall sense provides an apparatus and method for shutting-off electrical appliances and devices upon detection of an audible alarm issued by a separate fire alarm. The separate alarm device generates an audible alarm upon detecting fire and as is well known a fire alarm itself has independent function apart from its use in combination with the present invention as described below.

The warning sound produced by nearly all smoke alarms and other type fire alarms is a standard pattern. This standard pattern is ISO 8201 which is also commonly referred to as either the Temporal-Three alarm signal or “T-3” (three half second pulses, followed by a one and one half second pause). These ISO 8201 compliant smoke alarms are widely available at very low cost and exist in many residences and other buildings. An object of the present invention is to make use of these ubiquitous fire alarms to greatly reduce the cost and complexity of providing a power shut-off response in the case of fire. Accordingly, the present invention includes a microphone for detecting an audible alarm. In the present invention automatic cut-off apparatus it is unnecessary to include any fire detection sensors with the apparatus. As discussed above in the background of the invention, prior art automatic cut-off devices have their own fire detection sensors duplicating the functionality of a detection sensor on a preexisting laundry room fire alarm.

An apparatus for detecting and recognizing this ISO pattern and other audible alarm patterns is disclosed in related and commonly assigned U.S. patent application Ser. No. 13/770,392, filed Feb. 19, 2013, which is incorporated by reference herein. Also, U.S. Pat. No. 4,935,952 (Dutra) discloses a control system for detecting an audible fire-alarm and in response automatically dialing for emergency assistance. U.S. Pat. Nos. 4,935,952 and 7,477,142 (Albert et al.) is incorporated by reference. Upon detection of the audible alarm, the microcontroller may de-energize a normally-open relay or other switching device, to interrupt electrical power to an appliance.

An important aspect of present invention is that by employing an acoustic sensor to detect a standard fire alarm pattern from a separate fire alarm that whenever the separate fire alarm (e.g. smoke alarm in laundry room) happens to be replaced and upgraded to a newer improved fire alarm it follows that the performance of the automatic shut-off apparatus of the present invention is consequently upgraded. As discussed in the background above the technology for detecting fires has significantly advanced from its beginnings and likely will continue to improve and move ahead. As this fire detecting technology advances the fire fighting performance of the present invention will advance along with it without requiring any modification.

According to an aspect of the invention, a shut-off apparatus for stopping electrical power supply to a selected appliance or electrical device including a disconnect means and an audible alarm detector, and a control system that operates said disconnect means in response to said audible alarm.

Another second embodiment optionally supplements the detection of a separately-generated audible alarm with at least one independent local fault detection sensor that can be used to determine if a fire is present. Such local fault detection may include monitoring temperature, infrared radiation, particulate levels or other parameters that are known to have normal and abnormal ranges. The outputs of the audible alarm detector and the local fault detection sensor are logically combined (e.g. in an “OR” sense) to operate disconnect means shutting down electrical power to a selected appliance or electrical device. Having at least said two fire detection means provides an added measure of safety by the very nature of this embodiment's redundancy in using at least two detection means to identify a fire. This second embodiment enhances the efficiency of fire protection in comparison to fire detection by a single detection means.

According to an aspect of the invention, a shut-off apparatus for stopping electrical power supply to a selected appliance includes a disconnect means, an audible alarm detector, a local fault detector and a control system that operates said disconnect means.

Accordingly, it is an object of the present invention to provide an improved apparatus for selectively responding to an audible alarm tone within a housing in order to disconnect electrical power to an appliance.

Another aspect of the present invention is to provide an improved method and apparatus for responding to a fire alarm by disconnecting electrical power to a clothes dryer.

Another aspect of the present invention is to provide an improved method and apparatus for responding to either a fire alarm or a local fault detector by disconnecting electrical power to a clothes dryer.

Yet another aspect of the present invention, is the ease in which the automatic shut-off apparatus can be installed by an ordinary consumer. No hard wiring or complicated assembly is required. One embodiment of the present invention is as easy to install as plugging the automatic shut-off apparatus into a wall outlet then next plugging an appliance into an electrical receptacle on the automatic shut-off apparatus.

According to an aspect of the invention, a shut-off apparatus for stopping electrical power supply to a selected appliance or electrical device including a housing, a disconnect means and an audible alarm detector, wherein said housing includes a first side and an opposite side, said first side having an electrical plug for connecting the shut-off apparatus to an electrical outlet and an opposite side having a receptacle for receiving said selected appliance plug or said electrical device plug.

Still another aspect of the invention is to provide an automatic cut-off apparatus that includes a control system that disconnects electrical power to an appliance or other electrical device in response to a standard fire alarm tone.

The term “appliance” as used herein should be given its standard meaning in the art and therefore includes a wide range of appliances including but not limited to clothes dryers, conventional ovens, microwave ovens, toasters, space heaters, hair dryers, other cooking appliances and other fire potential domestic and commercial electrical/electronic devices.

The term “audible alarm” should be understood to mean an audible sound generated by an electrical or electronic device warning of danger.

The term “control system” as used herein should be understood to mean electronic and electrical logic controls including but not limited to hard wired relay systems, programmable logic relays, programmable logic controllers and microcontrollers.

The term “disconnect means” as used herein should be understood to mean a power interrupting switch including but not limited to an electromagnetic relay or solid-state relay.

The term “local fault detector” as used herein should be understood to include within its meaning a temperature sensor, infrared photo-detector, optical opacity sensor, or other transducers sensitive to physical parameters that are known to have normal ranges in the absence of fire and abnormal ranges under the condition that a fire arises.

The term “smoke alarm” as used herein is a device that automatically generates an audible alarm and includes but is not limited to an audible alarm activated by either a photoelectric sensor, an ionization sensor, chemical detectors of combustion products or other sensor types that respond upon contact with heat, smoke, certain combustion chemicals, or any other stimuli indicative of a fire. The smoke alarm may employ only one of the sensors listed immediately above or these sensors may be used in combination to activate the audible alarm.

The term “fire alarm” as used herein is a device that generates an audible alarm and includes but is not limited to “smoke alarms” as defined immediately above, in addition a “smoke alarm” also includes devices that generates an audible alarm upon activation by a temperature sensor or a device that can be manually activated at a fire alarm pull station. A “fire alarm” device may employ only a heat sensor or only one of the sensors listed under “smoke alarms”, or alternatively a “fire alarm” may have a combination of these sensors.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

### BRIEF DESCRIPTION OF THE DRAWINGS

FIG. 1 is a perspective view of a first embodiment of the appliance shut-off apparatus of the present inventions as it would be employed in a residential laundry room.

FIG. 2 is a block diagram of a control system of the first embodiment of the invention.

FIG. 3 is a block diagram of a control system of a second embodiment of the invention.

### DESCRIPTION OF THE PREFERRED EMBODIMENTS

Unless defined otherwise, all technical and scientific terms used herein have the same meaning as commonly understood by one of ordinary skill in the art to which this disclosure belongs.

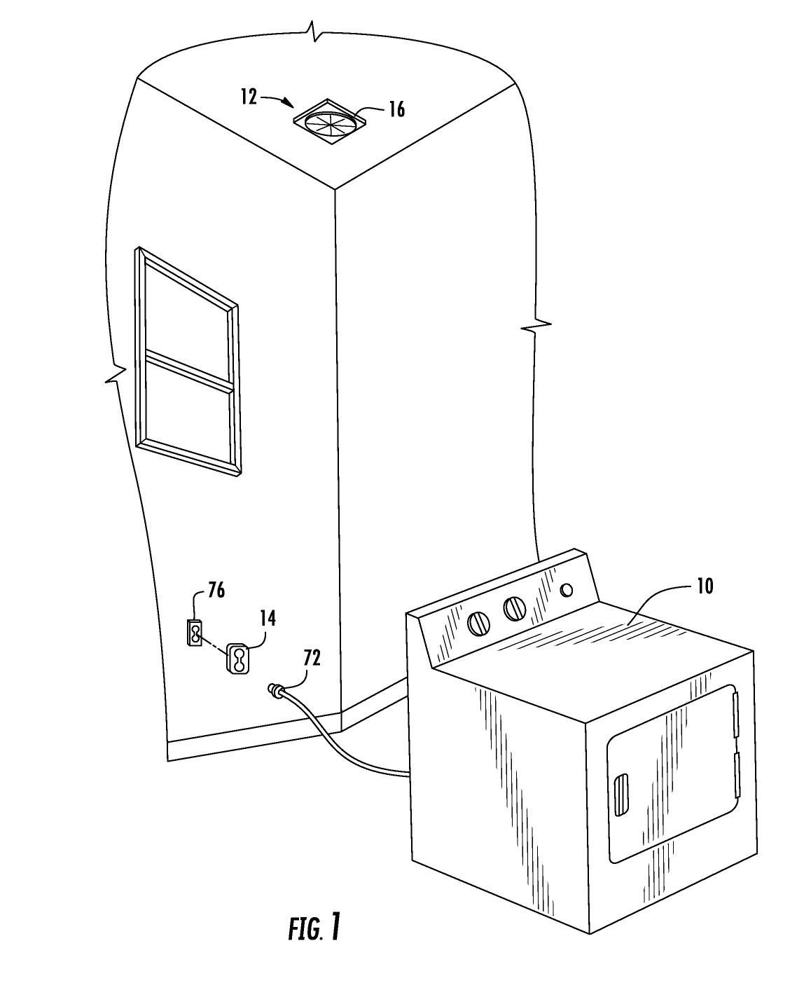

The automatic appliance shut-off apparatus of the present invention is identified as number 14 in FIG. 1. FIG. 1 illustrates a laundry room having a clothes dryer 10 and a smoke alarm 16 mounted on the ceiling 12 of the laundry room. The clothes dryer has a grounded electrical plug 72 for connecting to electrical power. A wall in the laundry room is provided with an electrical outlet 76, in general most laundry rooms have a previously installed standard 220/240 VAC grounded electric socket. In the prior art the clothes dryer plug 72 is typically plugged directly into the wall outlet 76.

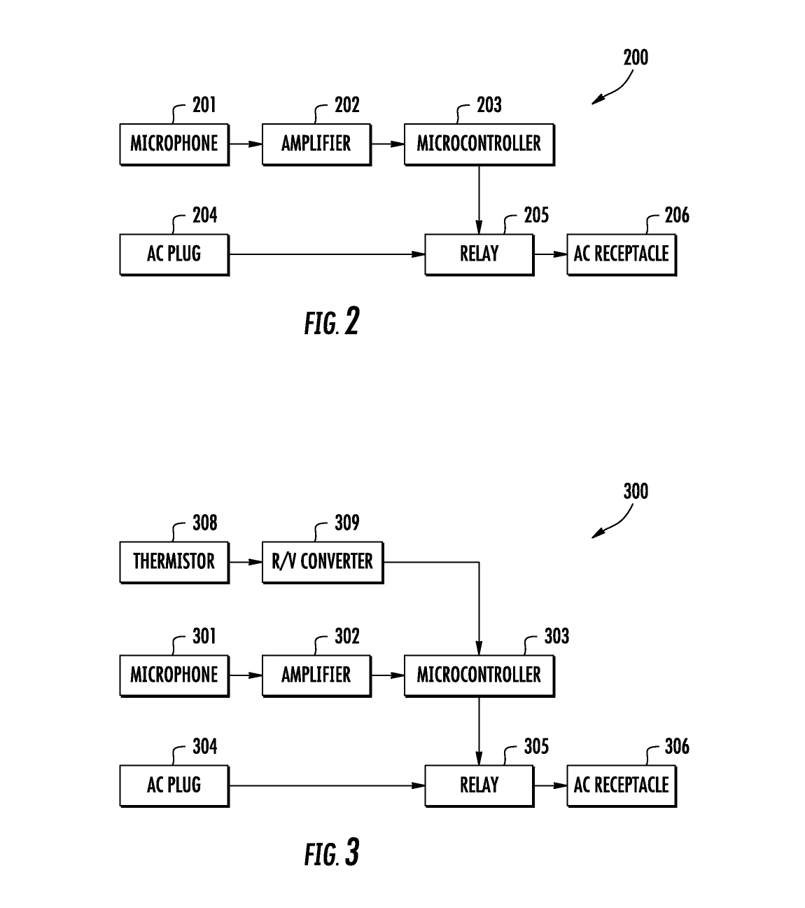

The appliance shut-off apparatus of the present invention 14 has a grounded 220/240 VAC plug on a first side of its housing for plugging in the wall outlet 76 and on the opposite side of its housing it has a receptacle for receiving a grounded 220/240 VAC plug. On the receptacle side the shut-off apparatus 14 housing is also provided with an exposed microphone, the microphone senses acoustic noises in the laundry room and is employed for sensing an audible alarm. The shut-off apparatus housing has a control system inside for shutting-off electrical power at its receptacle in response to sensing an acoustic fire alarm. The control system is powered by electrical power supplied from the wall outlet. A block diagram of the control system is shown in FIG. 2.

In FIG. 2, a first control system 200 of the present invention for de-powering an electrical appliance is shown. It includes an AC plug 204 which connects to a source of utility power, AC receptacle 206 into which an appliance plug is inserted for receiving power, and electromagnetic relay 205 interposed between plug 204 and receptacle 206. An operating coil of relay 205 is controlled by a microcontroller 203 of the type commonly used in industry and well known in the art. A microphone 201 is connected to an amplifier 202 for inputting an acoustic signal to the microcontroller 203. Microcontroller 203 is programmed to selectively detect the occurrence of an audible alarm issued by a fire alarm, and upon detection of such audible fire alarm, de-activates relay 205 thereby shutting off power at the receptacle 206. It is preferable for relay 205 to be of the normally-open type, to provide fail-safe operation in the event that microcontroller 203 should malfunction. Preferably, the aforesaid components of the system 200 are all integrated into a single shut-off apparatus housing 14, providing for a low cost product that is as easy to install as plugging the apparatus into a wall outlet, then next plugging a selected appliance into the electrical receptacle of shut-off apparatus 14. Relay 205 may be of the conventional, magnetic-coil, or solid-state variety well known in the art.

FIG. 3 illustrates a second alternative control system 300 of the present invention. The control system 300 like the first control system embodiment 200 may be used for de-powering an electrical appliance. The control system 300 includes an AC plug 304 which connects to a source of utility power, AC receptacle 306 into which an appliance plug is inserted for receiving power, and an electromagnetic relay 305 interposed between plug 304 and receptacle 306. The relay 305 is operated by microcontroller 303. A microphone 301 is connected to an amplifier 302 for inputting an acoustic signal to the microcontroller 303. Similar to the first embodiment microcontroller 303 is programmed to selectively detect the occurrence of an audible fire alarm, and upon detection of such audible fire alarm, deactivates relay 305 thereby shutting off power at the receptacle 306. Relay 305 may be of the conventional, magnetic-coil type, or solid-state variety well known in the art.

In the second embodiment of the present invention, an additional sensor is connected to microcontroller 303: thermistor 308 is connected to resistance-to-voltage converter circuit 309 for inputting a temperature signal to the microcontroller 303. In one exemplary use, thermistor 308 may be placed in direct thermal contact with an appliance plugged into receptacle 306. This thermistor would be connected by a wire to the microcontroller in the shut-off apparatus 14 housing. This appliance may be an appliance that has a greater potential of catching on fire. All electrical appliances have a normal operating temperature range; microcontroller 303 is programmed to monitor the thermistor 308, and if the thermistor indicates an excursion of temperature outside of the appliance's normal operating range microcontroller 303 opens relay 305 thereby shutting off power at the receptacle 306. Preferably, microcontroller 303 only shuts-off electrical power to the appliance for temperature excursions that exceed the detection threshold by a given combination of magnitude and time. Shutting-off this appliance upon either detection of a smoke alarm or upon detection of extended temperature excursions, provides an added measure of safety by the very nature of the system's redundancy in using two detectors to identify a fire, improving the likelihood of detecting a fire.

The fire warning temperature for an appliance is preferably chosen to be above the maximum normal operating temperature occurring at the location of the thermistor, by a small margin (e.g., 5 C) to prevent false-positive detection. For clothes dryers and many other household appliances a fire warning temperature threshold of approximately 60 degrees C. to 70 degrees C. would be appropriate since this range is usually above normal maximum operating temperatures of exposed surfaces of household appliances, but far below the temperatures that may be reached in the event of a fire. It should be recognized that other maximum allowable temperatures can be selected for clothes dryer and/or the placement of the thermistor on the dryer can be varied. For instance the present invention control system can be programmed so that the internal cabinet temperature of the dryer does not exceed the combustion temperature of lint.

It will be recognized that reliance on an audible alarm from a separate fault-detection device (e.g., a smoke alarm) results in the possibility of either control system embodiment of the present invention responding to fault conditions unrelated to the electrical power being supplied to the appliance. However, in typical installations of protective devices, the consequences of such “false positive” detections are minimal, while the consequences of failing to automatically respond to a true appliance fault can be much more serious.

Shutting off any appliance upon either detection of a smoke alarm or upon detection of excessive temperature, provides a beneficial safety measure of redundancy and improves the likelihood of detecting a fire. It is contemplated that for some appliances different sensors other than a temperature sensor may be selected as a local fault detector. Such selected sensor would be chosen in accordance with its capacity to predict or evidence a fire hazard. In addition more than one local fault detector may be incorporated with the present invention.

Preferred embodiments of the present invention have just been described and illustrated above. It is to be understood that these descriptions are only exemplary, for the control system may be modified greatly without departing from the concepts of the present invention. Those of ordinary skill in the art will recognize that these embodiments may be modified and altered without departing from the central spirit and scope of the invention.

The term “connected” is to be construed as partly or wholly contained within, attached to, or joined together, even if there is something intervening. The use of any and all examples, or exemplary language (e.g., “such as”) provided above, is intended merely to better illuminate embodiments of the invention and does not pose a limitation on the scope of the invention unless otherwise claimed. No language in the specification should be construed as indicating any non-claimed element as essential to the practice of the invention.

The scope of the invention being indicated by the appended claims rather than the foregoing descriptions and all changes which come within the meaning and range of equivalency of the claims are intended to be embodied herein.

The invention claimed is:

1. A shut-off apparatus for stopping electrical power supply to a selected appliance or electrical device comprising:
a disconnect means, and
an audible alarm detector.

2. A shut-off apparatus for stopping electrical power supply to a selected appliance or electrical device as recited in claim 1 further comprising:
a control system that operates said disconnect means in response to detection of an audible alarm.

3. A shut-off apparatus for stopping electrical power supply to a selected appliance or electrical device as recited in claim 1 wherein said audible alarm detector is a microphone.

4. A shut-off apparatus for stopping electrical power supply to a selected appliance or electrical device as recited in claim 2 wherein said audible alarm detector is a microphone.

5. A shut-off apparatus for stopping electrical power supply to a selected appliance or electrical device as recited in claim 2 wherein said control system is programmed to detect a standard fire alarm.

6. An shut-off apparatus for stopping electrical power supply to a selected appliance or electrical device comprising:
a housing;
a disconnect means, and
an audible alarm detector,
wherein said housing includes a first side and an opposite side, said first side having an electrical plug for connecting the shut-off apparatus to an electrical outlet and an opposite side having a receptacle for receiving said selected appliance plug or said electrical device plug.

7. A shut-off apparatus for stopping electrical power supply to a selected appliance or electrical device as recited in claim 6 further comprising:
a control system that operates said disconnect means in response to detection of an audible alarm.

8. A shut-off apparatus for stopping electrical power supply to a selected appliance or electrical device as recited in claim 7 wherein said control system and said disconnect means are enclosed in said housing.

9. A shut-off apparatus for stopping electrical power supply to a selected appliance or electrical device as recited in claim 8 wherein said audible alarm detector is a microphone.

10. A shut-off apparatus for stopping electrical power supply to a selected appliance or electrical device as recited in claim 8 wherein said control system is programmed to detect a standard fire alarm.

11. A shut-off apparatus for stopping electrical power supply to a selected appliance or electrical device comprising:
a disconnect means;
an audible alarm detector, and
a local fault detector.

12. A shut-off apparatus for stopping electrical power supply to a selected appliance or electrical device as recited in claim 11 further comprising:
a control system that operates said disconnect means in response to detection of an audible alarm or extended temperature excursions.

13. A shut-off apparatus for stopping electrical power supply to a selected appliance or electrical device as recited in claim 11 wherein said audible alarm detector is a microphone.

14. A shut-off apparatus for stopping electrical power supply to a selected appliance or electrical device as recited in claim 12 wherein said audible alarm detector is a microphone.

15. A shut-off apparatus for stopping electrical power supply to a selected appliance or electrical device as recited in claim 12 wherein said control system is programmed to detect a standard fire alarm.

16. A shut-off apparatus for stopping electrical power supply to a selected appliance or electrical device as recited in claim 11 wherein said local fault detector is a thermistor.

17. A shut-off apparatus for stopping electrical power supply to a selected appliance or electrical device as recited in claim 12 wherein said local fault detector is a thermistor.

18. A shut-off apparatus for stopping electrical power supply to a selected appliance or electrical device as recited in claim 12 further comprising:
a housing, wherein said housing has a first side and an opposite side, said first side having an electrical plug for connecting the shut-off apparatus to an electrical outlet and an opposite side having a receptacle for receiving said selected appliance plug or said electrical device plug.

19. A shut-off apparatus for stopping electrical power supply to a selected appliance or electrical device as recited in claim 18 wherein said control system and said disconnect means are enclosed in said housing.

20. A shut-off apparatus for stopping electrical power supply to a selected appliance or electrical device as recited in claim 19 wherein said control system is programmed to detect a standard fire alarm.
